(19) United States
(12) Patent Application Publication
(10) Pub. No.: US 2026/0326225 A1
(43) Pub. Date: Oct. 22, 2026

(54) BRAZE REPAIR USING HOT ISOSTATIC PRESSURE ENVIRONMENT

(71) Applicant: Rolls-Royce Corporation, Indianapolis, IN (US)

(72) Inventor: Scott Nelson, Indianapolis, IN (US)

(21) Appl. No.: 19/180,677

(22) Filed: Apr. 16, 2025

(51) Int. Cl. B23K 1/008; B23K 1/00; B23K 3/08; B23K 101/00

(52) U.S. Cl. CPC B23K 1/008; B23K 1/0018; B23K 3/08; B23K 2101/001

(57) ABSTRACT

A technique for brazing includes applying a braze material to a substrate, the braze material comprising a low-melt component and a high-melt component. The technique includes outgassing, while the braze material is under vacuum, volatile components from the braze material. The technique also includes performing a braze cycle, wherein performing the braze cycle comprises applying heat to the braze material to at least soften the low-melt component of the braze material. The technique includes performing a diffusion cycle, wherein performing the diffusion cycle comprises applying heat to the braze material to diffuse the braze material into the substrate to join the braze material to the substrate. At least one of the braze cycle or the diffusion cycle comprises performing a hot isostatic pressure (HIP) cycle, wherein performing the HIP cycle comprises applying elevated atmospheric pressure in conjunction with the heat applied to the braze material.

### TECHNICAL FIELD

The disclosure generally relates to brazes for repairing components.

### BACKGROUND

An increasing need for higher gas turbine engine efficiency and performance has led to increasing gas turbine engine operating temperature. The increased operating temperatures may result in additional damage and wear to turbine components such as blades and vanes. The damaged components may be repaired rather than being discarded and replaced.

### SUMMARY

Damaged components (e.g., gas turbine engine components such as blades and vanes) may be repaired using a braze repair process. A braze repair technique generally includes applying a braze material to a damaged substrate, outgassing volatile components from the braze material under vacuum, performing a braze cycle by heating the substrate and braze material to at least soften and flow the braze material, performing a diffusion cycle by heating the substrate and braze material to join the braze material to the component, and cooling the substrate to form a braze-repaired component. Optionally, a rejuvenation cycle, which involves heating the substrate and braze material to modify a microstructure of the braze material and/or the substrate, may be included subsequent to the diffusion cycle. After repairing the component, the repaired brazed component can be put back into service rather than replacing the entire damaged component.

Braze repair processes may be applicable to some turbine components. However, several quality and efficiency problems may prevent the wider application of this technology. For example, voids may be created in the braze material or the substrate material during the outgassing step, which may result in degraded performance of the repair area. Furthermore, braze repair processes may be relatively labor, time, and/or energy intensive. Improvements to throughput and efficiency of braze repair processes may enable increased availability and quality of braze-repaired components.

In accordance with one or more examples of the present disclosure, a hot isostatic pressure (HIP) cycle may be included as one or more of the braze cycle, the diffusion cycle, or the rejuvenation cycle. A hot isostatic pressure cycle may also be called a high isostatic pressure cycle. During a HIP cycle, elevated atmospheric pressure may be applied to the substrate and braze material in conjunction with the heat. The application of a HIP cycle as one or more of the braze cycle, diffusion cycle, and/or the rejuvenation cycle may improve the quality of the repair area by reducing or eliminating voids or porosity in the repair region. The increased atmospheric pressure of the HIP cycle may enable reduced temperature in the processing environment, which may reduce thermal stresses input into the substrate and further improve quality or open up braze-repair processes to other components. Furthermore, application of a HIP cycle or multiple may enable improved throughput and/or increased efficiency.

In one example, a technique for brazing includes applying a braze material to a substrate, the braze material comprising a low-melt component and a high-melt component. The technique includes outgassing, while the braze material is under vacuum, volatile components from the braze material. The technique also includes performing a braze cycle, wherein performing the braze cycle comprises applying heat to the braze material to at least soften the low-melt component of the braze material. The technique includes performing a diffusion cycle, wherein performing the diffusion cycle comprises applying heat to the braze material to diffuse the braze material into the substrate to join the braze material to the substrate. At least one of the braze cycle or the diffusion cycle comprises performing a hot isostatic pressure (HIP) cycle, wherein performing the HIP cycle comprises applying elevated atmospheric pressure in conjunction with the heat applied to the braze material.

In one example, a system for forming a brazed component includes a chamber configured to receive a substrate with braze material applied to the substrate and contain the substrate within a processing environment. The system includes a vacuum system configured to evacuate gases from the processing environment, a pressurized fluid system configured to inject fluid into the processing environment to elevate an atmospheric pressure in the processing environment, and a heating system configured to add thermal energy to the processing environment to increase a temperature of the processing environment. The system includes processing circuitry. The processing circuitry is configured to actuate the vacuum system to reduce the atmospheric pressure in the processing environment to outgas volatile components from the braze material, actuate the heating system to perform a braze cycle to at least soften a low-melt component of the braze material, and actuate the heating system to perform a diffusion cycle to diffuse the braze material into the substrate to join the braze material to the substrate. The processing circuitry is configured to actuate the pressurized fluid system to inject fluid into the processing environment to increase the atmospheric pressure in the processing environment during at least one of the braze cycle or the diffusion cycle. At least one of the braze cycle or the diffusion cycle comprises a hot isostatic pressure (HIP) cycle. The processing circuitry is further configured to deactivate the heating system to cool the substrate to form a brazed component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating a hot isostatic pressure (HIP) system, in accordance with one or more examples of the present disclosure.

FIG. 2 is a flowchart illustrating a technique for repairing a component by brazing, in accordance with one or more examples of the present disclosure.

FIG. 3 is a flowchart illustrating a technique for repairing a component by brazing, in accordance with one or more examples of the present disclosure.

### DETAILED DESCRIPTION

Damaged components (e.g., gas turbine engine components such as blades and vanes) may be repaired using a braze repair process. One example braze repair process is wide gap brazing. In wide gap brazing, a paste, tape, or putty may be used to fill a gap that is at least about 0.5 millimeters (mm) wide. The gap may surround a perimeter of a preform used to replace a damaged portion of the substrate.

A braze repair technique generally includes applying a braze material to a damaged substrate, outgassing volatile components from the braze material under vacuum, performing a braze cycle to at least soften and flow the braze material, performing a diffusion cycle to join the braze material to the component, and cooling the substrate to form braze-repaired component. Optionally, a rejuvenation cycle to modify a microstructure of the braze material and/or the substrate may be included subsequent to the diffusion cycle. The brazed component can be put back into service rather than replacing the entire component.

Braze repair processes may be applicable to many turbine components. For example, components that include superalloys such as nickel superalloys may be eligible for braze repair processes. However, several quality and efficiency problems may prevent the wider application of this technology. For example, voids may be created through material and consumable outgassing. Furthermore, the substrate material in the unrepaired region of the component may be deleteriously impacted. These issues may increase the percentage of non-conforming parts due to excessive voids, degrade the performance of the repaired material and increase the risk of failure in relatively high-stress applications. The risk of failure, either through a high incidence rate for the formation of voids or the failure of the repair/component have prevented the application of wide gap braze repair in more critical or higher stressed components and regions.

In accordance with one or more examples of the present disclosure, a hot isostatic pressure (HIP) cycle may be included as one or more of the braze cycle, the diffusion cycle, or the rejuvenation cycle. A hot isostatic pressure cycle may also be called a high isostatic pressure cycle. During an HIP cycle, elevated atmospheric pressure (e.g., pressure greater than an ambient atmospheric pressure, such as at least 10 megapascals (MPa), at least 50 MPa, or at least 100 MPa greater than the ambient atmospheric pressure) may be applied to the substrate and braze material in conjunction with the heat applied during these processes. The application of a HIP cycle as one or more of the braze cycle, diffusion cycle, and/or the rejuvenation cycle may improve the quality of the repair area by reducing or eliminating voids or porosity in the brazed region. The increased atmospheric pressure of the HIP cycle may enable reduced temperature in the processing environment, which may reduce thermal stresses input into the substrate and further improve quality or open up braze-repair processes to other components. Furthermore, application of a HIP cycle or multiple may enable improved throughput, decreased cycle time, and/or decreased temperatures.

The HIP cycle may be done during the braze cycle, when the applied braze material is heated to a semi-liquid state, or post-brazing during the diffusion heat treatment cycle, when the composition of the repaired area is homogenized with the parent material, or during a subsequent rejuvenation step where the braze material is reheated to restore the component microstructure. Although generally described as including each of a braze cycle, a diffusion cycle, and a rejuvenation cycle, the described techniques need not include each of these heat treatment cycles. For example, the diffusion cycle and the rejuvenation cycle may be combined into the diffusion cycle such that the technique only includes a braze cycle and a diffusion cycle as distinct heating steps. In some examples, the braze cycle, diffusion cycle, and rejuvenation cycle may be merged into a single heating and pressure step.

The increased pressure of the HIP stage may provide benefits including improved quality, reduced temperatures during the heating step, and reduced cycle time no matter which step the HIP cycle is employed in. Expanding further on the benefits of inclusion of at least one HIP cycle include the elimination of voids in repaired material from solidification or outgassing during heating cycle. Eliminating or minimizing voids may be relatively important when the braze material includes a braze paste. For example, the reduction of voids may increase the average mechanical performance of the repair region and may also decrease rejected repairs due to non-conforming internal defects. Similarly, the reduction or elimination of voids may result in the reduction or elimination of service-induced porosity in the substrate.

Additionally, the inclusion of at least one HIP cycle may yield increased diffusion rates due to pressure increases. The increased diffusion rates may enable reduced heating cycle times or temperatures and thus improved temporal and/or energy efficiency of the repair process. Additionally, the HIP cycle may more efficiently eliminate intermetallic phases in the repaired region and surrounding substrate material, yielding a braze-repaired component with increased ductility and/or decreased presence of non-conforming continuous eutectic phases. Other benefits may include improved infiltration of braze material into tight cracks, which could result in better quality crack repairs and improved process yield. Moreover, in some examples, the substrate may exhibit a desirable gamma/gamma-prime microstructure, which may degrade during the braze repair process. The desirable gamma/gamma-prime microstructure may be rejuvenated during a HIP cycle, which may extend component life.

In some cases, inclusion of two HIP cycles, or even three separate HIP cycles, with each HIP cycle separated by a period of cooling (e.g., without the input of thermal energy), may provide marginal benefit. For example, inclusion of a HIP cycle during one of the stages may yield one or more of the above-described benefits, and inclusion of a second HIP cycle may yield further improvements. In some examples, still further benefits may be achieved by moving from a technique which includes two HIP cycles to a technique which includes three HIP cycles.

The disclosed braze repair techniques may be performed with a HIP system. The disclosed HIP systems may allow for flexibility in processing parameters, enabling portions of the braze process to occur in vacuum and enabling use of rapid gas quenching. In a summary of a braze technique using the disclosed HIP systems, the HIP system may allow for the substrate and braze material to come to temperature in a vacuum to allow for the outgassing of organic binders. The substrate may be pressurized and heated to a braze temperature in a chamber in a braze cycle. The braze cycle temperature may be lower than non-pressurized braze cycles due to pressure effects. In some examples, the substrate would then be cooled (e.g., actively cooled by a cooling subsystem, quenched below the solidus temperature of the low-melt material by injection of relatively cool gases, or the like), then reheated and repressurized to homogenize the composition and rejuvenate/restore the component microstructure during a diffusion cycle, followed by cooling to room temperature.

Thus, advantageously, the disclosed HIP systems may enable completion of a complete braze process without additional touches of the component by an operator after application of the braze material. After loading the substrate and braze material into the chamber, volatile materials may be outgassed under vacuum, a braze cycle, a diffusion cycle, an optional rejuvenation cycle, and one or more intervening cooling steps may be performed without removing the component from the chamber. The disclosed systems and techniques may therefore allow for reduced labor costs and/or reduced footprint of brazing systems relative to systems which include disparate equipment to perform the various steps.

For example, HIP systems disclosed herein may include a chamber which receives a substrate with braze material applied to the substrate. The substrate may be a damaged component of a gas turbine engine such as a blade, a vane, or the like. A damaged portion of the component may be removed to create a repair region. The component may include a superalloy, such as a single-crystal superalloy that includes nickel as a primary component.

The braze material may be applied to the repair region of the component. May be configured as one or more of a braze paste, a braze putty, a braze tape, or a preform. In some examples, a preform may be tailored to fille a large portion of the repair region, and a braze paste may surround a perimeter of the preform to repair the component. No matter how the braze material is packaged, the braze material may include multiple components. For example, the braze material may include a low-melt component, a high-melt component, and one or more filler or binder materials. In some cases, the high-melt material may substantially match the substrate material (e.g., both include nickel superalloys). The low-melt material may promote flowability of the braze material into cracks and crevices at least partially softening (e.g., melting) at a lower temperature than the high melt material.

Cleanliness is important to any successful braze repair. Before placing the substrate and braze material in a processing environment contained by the chamber, the chamber may be cleaned. To clean the chamber in preparation for the braze, a pressurized fluid subsystem may inject hydrogen into the chamber to remove any oxides, organics, or other contaminants. Other suitable cleaning techniques may include actuating a vacuum system to evacuate the processing environment, or performing some other thermochemical cleaning technique, or the like.

In addition to the chamber containing the processing environment and the pressurized fluid subsystem, the HIP system may include other subsystems configured to execute the brazing process under control of a computing device. The computing device may include processing circuitry that is configured to actuate the various subsystems to perform the various steps of the brazing process. Although functionality described herein is described as belonging to a particular subsystem, it is understood that the computing device may a different subsystem to perform the described functionality, or two subsystems may share the described functionality. It is considered that the processing circuitry may actuate the various subsystems to perform the brazing technique automatically according to a program. Alternatively, the processing circuitry may be configured to receive user inputs to actuate the various subsystems to perform the brazing technique. In some examples, the described HIP system may further include a pressurized fluid subsystem, a vacuum subsystem, a heating system, and a cooling system.

Generally, the pressurized fluid subsystem system may inject fluid into the processing environment to inject fluid into the processing environment to inject fluid into the processing environment. The pressurized fluid subsystem may include one or more fluid sources (e.g., compressed gas tanks), a pump, a compressor, and associated plumbing. The pressurized fluid subsystem may include a pressure sensor disposed in the processing environment. The pressure sensor may be in in electrical communication with the pressurized fluid subsystem to provide feedback control of the pressure within the processing environment.

The vacuum system may evacuate gases from the processing environment. For example, the processing circuitry may actuate a vacuum pump to remove and expel gases from the processing environment. The vacuum subsystem may include a pressure sensor disposed in the processing environment. The pressure sensor may be in in electrical communication with the vacuum subsystem to provide feedback control of the pressure within the processing environment.

HIP systems disclosed herein may further include a heating subsystem configured to add thermal energy to the processing environment to increase the temperature of the processing environment. The heating subsystem may include an induction coil which heats the processing environment directly, or may preheat incoming gases from the pressurized fluid system, or both. Optionally, a cooling subsystem may be included configured to cool the processing environment during a cooling or quenching step. In examples where a cooling subsystem is included, the cooling subsystem may include an evaporator coil. Alternatively, the processing environment may be cooled by deactivated the heating subsystem, or by injecting relatively cool external gases with pressurized fluid subsystem. One or both of the heating subsystem or the cooling subsystem may be in electrical communication with a temperature sensor disposed in the processing environment. to provide feedback control of the temperature within the processing environment.

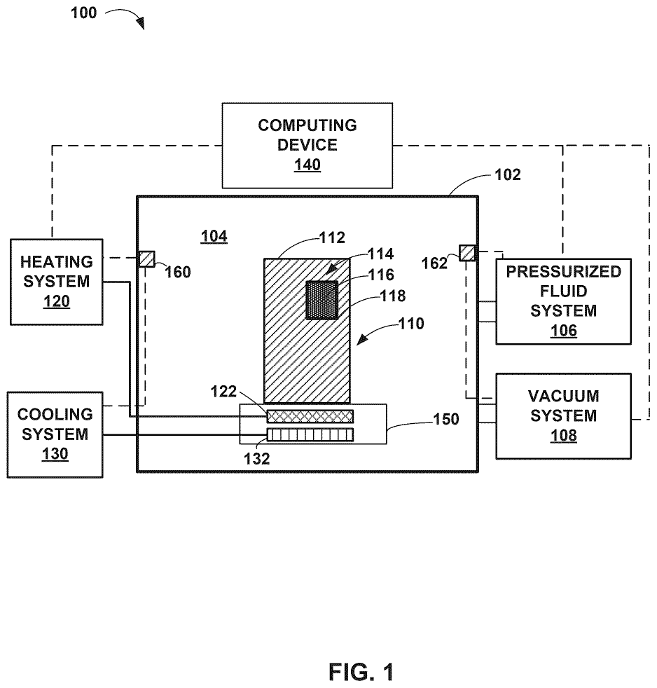

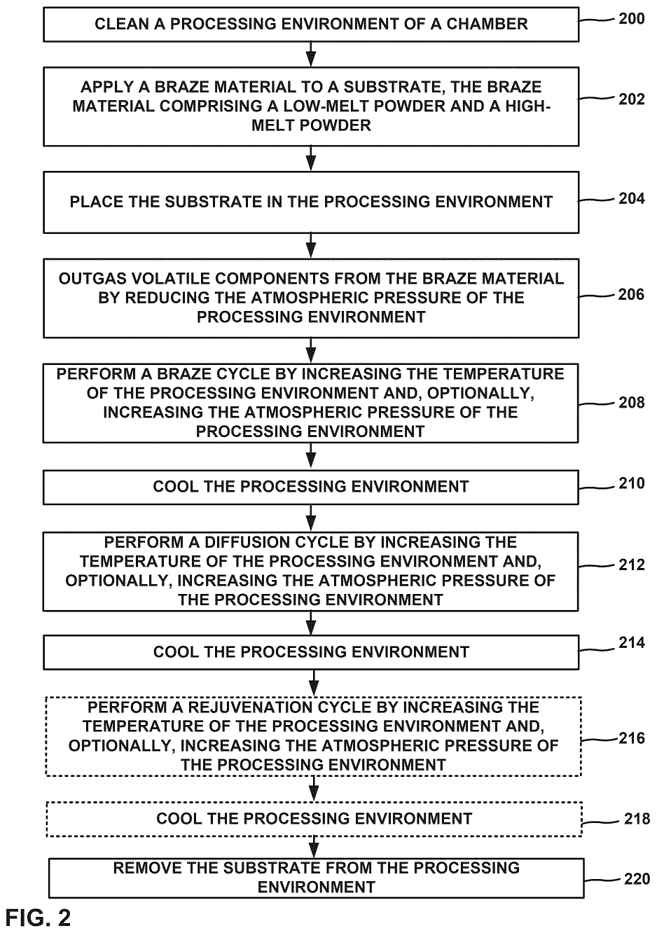

FIG. 1 is a conceptual block diagram illustrating hot isostatic pressure (HIP) system 100, in accordance with one or more examples of the present disclosure. FIG. 2 is a flowchart illustrating a technique for repairing a component by brazing, in accordance with one or more examples of the present disclosure. System 100 of FIG. 1 will be described in conjunction with the technique of FIG. 2, although system 100 may be used to perform other techniques, and the described techniques may be performed with other systems.

HIP system 100 includes chamber 102, pressurized fluid subsystem 106, vacuum subsystem 108, heating subsystem 120, cooling subsystem 130, and computing device 140. System 100 may function in operation to repair substrate 112 of component 110 in repair region 114 by a wide gap brazing process. It is also considered that the described systems and techniques may be applied to a fabrication process of a component which include braze material positioned in a joint region.

Computing device 140 may include, for example, a desktop computer, a laptop computer, a workstation, a server, a mainframe, a cloud computing system, or the like. Computing device 140 is configured to control operation of system 100, including, for example, pressurized fluid subsystem 106, vacuum system 108, heating system 120, and cooling system 130. Computing device 140 may be communicatively coupled to these various subsystems using any suitable communication connection. In some examples, the communication connection may include a network link, such as Ethernet, ATM, or another network connection. Such connection may be wireless and/or wired. In other examples, the communication connection may include other types of device connection, such as USB, IEEE 1394, or the like.

In some examples, computing device 140 may include control circuitry, such as one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure. Regardless of the particular structure of the processing circuitry, the processing circuitry of computing device 140 control components and subsystems to cause actuation, adjustment, and deactivation of the various subsystems and components to perform a braze repair process. In some examples, computing device 140 may further include a memory. The memory may have instructions stored thereon that, when executed by the processing circuitry, cause the various subsystem to perform the braze repair process.

Chamber 102 defines processing environment 104. Chamber 102 maintains a sealed environment for processing environment 104 such that thermal energy and pressure may be added to and/pr taken away from processing environment 104 in operation to heat and/or pressure treat substrate 112 and the braze material. In some examples, chamber 102 may be a furnace that defines processing environment 104 as an internal cavity. Chamber 102 may include inlets and outlets for interaction with the various subsystems of system 100. In some examples, chamber 102 may define stage 150, which may mechanically support one or more components 110 during operation. Stage 150 may, in some cases, be arranged as a series of shelves configured to mechanically support a plurality of components.

Chamber 102 may house component 110 in processing environment 104. Component 110 may include substrate 112. In some examples, component 110 may define an article or a portion of an article that is part of a high temperature mechanical system. For example, component 110 may include a gas turbine engine blade, gas turbine engine vane, blade track, combustor liner, a pressure vessel of a gas turbine engine such as an outer combustion chamber, or the like.

Substrate 112 may include a metal or alloy formed using, for example, casting, forging, powder metallurgy, and/or additive manufacturing. In some examples, substrate 112 may include a Ni-, Co-, Fe-based high temperature alloy; Hastelloy X, Hastelloy W, or Haynes 230 available from Haynes International, Kokomo, Indiana; Stellite 31 (e.g., X-40) available from Kennametal, Latrode, Pennsylvania; or the like. In some examples, substrate 112 may include a Ni-, Co-, Fe-based superalloy, or the like. In examples in which substrate 112 includes a superalloy, substrate 112 may include other additive elements to alter its mechanical and chemical properties, such as toughness, hardness, temperature stability, corrosion resistance, oxidation resistance, and the like, as is known in the art. Any useful superalloy may be utilized in substrate 112, including, for example, Ni-based alloys, such as MAR-M246 or MAR-M247, available from Martin-Marietta Corp., Bethesda, Maryland; Ni-based alloys, such as CMSX-3, CMSX-4, CMSX-10, and CM-186, available from Cannon-Muskegon Corp., Muskegon, Michigan; Co-based alloys, such as MAR-M509, available from Martin-Marietta Corp., Bethesda, Maryland; and the like.

Braze material may be applied to repair region 114 of substrate 112 that may have been damaged during operation of a high temperature system (e.g., an aircraft). Braze material may be configured as one or more of a braze paste, a braze foil, a braze putty, a braze tape, or a preform. In the illustrated example, preform 116 may cover a large portion of repair region 114, and braze paste 118 may surround a perimeter of preform 116 to repair component 110. No matter how the braze material is packaged, the braze material may include multiple components. For example, the braze material may include a low-melt component, a high-melt component, and one or more filler or binder materials. In some cases, the high-melt component may substantially match the substrate material (e.g., both include nickel superalloys). The low-melt component may have a lower melting point than the high-melt component, and may thus promote flowability of the braze material into cracks and crevices by least partially softening (e.g., melting) at a lower temperature than the high-melt component.

Preform 116 and braze paste 118 may include a mixture of powder braze materials. Braze paste 118 may include additional fillers and/or binders to package the braze material as a paste. The fillers and/or binders may include organic or polymeric materials which volatilize at relatively low temperatures (e.g., less than about 500° C.). Preform 116 may have been sintered to form a pre-sintered preform. Sintering may reduce porosity compared to the powder, which may reduce porosity in preform 116 during and after brazing. In some examples, the mixture of powder material defining preform 116 may include a conforming braze material, such as Ni-based, Fe-based, or Co-based wide gap braze alloy. A conforming braze material may include a composition of metal or alloy powders configured to sufficiently soften to conform to surface contours of a substrate and reduce gross liquidation and/or flow of the constituents of the conforming braze material that are melted during brazing. By conforming to surface contours of a substrate, a conforming braze material may improve substrate/reinforcement contact, improve bond strength, or both. By reducing gross liquidation and/or reflow, a conforming braze material may be used, for example, to reinforce a component that includes cooling holes (or other features) into (or onto) which other braze materials may flow during brazing. In these ways, a conforming braze material may be configured to, during brazing, conform to surface contours of a substrate having a complex geometry without flowing off the substrate or otherwise deforming in shape.

In some examples, preform 116 may include greater amounts of alloying elements than braze paste 118, which surrounds a perimeter of preform 116 and joins preform 116 to a non-repaired portion of substrate 112. The greater amounts of alloying elements may contribute to improved mechanical properties, chemical properties, or both compared to other braze materials. For example, preform 116, after brazing, may possess sufficient mechanical strength and high temperature oxidation resistance to be used to form a portion of a gas turbine engine component.

In some examples, preform 116 and braze paste 118 may include both a braze alloy powder (e.g., a low-melt powder composition) and a superalloy powder (e.g., a high-melt powder composition). The low-melt alloy powder composition is an alloy, or a mixture of alloys, that substantially melts below a braze temperature. In contrast, the high-melt alloy powder composition is an alloy, or a mixture of alloys, that remains substantially unmelted at the braze temperature, because the composition has a melting temperature above the braze temperature. In some examples, the braze alloy powder and the superalloy powder may have specific powder mesh sizes, and may be produced by induction melting the braze alloy or the superalloy, respectively, in vacuum or an argon atmosphere, followed by argon gas atomization. Each individual powder component used in preform 116 may be analyzed to confirm, within common metallurgy tolerances, the particle size and chemical compositions.

In some examples, the low-melt powder composition includes an alloy or a mixture of alloys that melt at a temperature below about 1260° C. (about 2300° F.), with the alloy or mixture of alloys being selected so that the low-melt powder composition as a whole substantially melts at a temperature between about 1093° C. (about 2000° F.) and about 1260° C. (about 2300° F.). The high-melt alloy powder composition may include a single high-melt alloy or a mixture of alloys that melts at a temperature of greater than about 1315° C. (about 2400° F.).

In some examples, the low-melt powder composition may include one or more alloy powders and includes between about 50 wt. % and about 70 wt. % Ni, between about 8 wt. % and about 20 wt. % Cr, between about 8 wt. % and about 15 wt. % Ta, between about 4 wt. % and about 10 wt. % Co, between about 2 wt. % and about 7 wt. % Al, up to about 2.25 wt. % B, and up to about 2.25 wt. % Si, and has a compositional melting range of between about 1093° C. (about 2000° F.) and about 1204° C. (about 2200° F.). In some examples, the low-melt powder composition also includes up to about 1 wt. % each of at least one of Ti, W, Mo, Re, Nb, Hf, Pd, Pt, Ir, Ru, C, Si, P, Fe, Ce, La, Y, or Zr. In some examples the low-melt alloy powder comprises a mixture of two or more low-melt alloys. For example, a low-melt alloy powder may include (a) about 35% of a first low-melt powder including about 74 wt. % Ni, about 6 wt. % Cr, about 6 wt. % Al, about 12 wt. % Co, and about 2 wt. % B, with a liquidus temperature of about 1121° C. (about 2050° F.); (b) about 45% of a second low-melt powder including about 42 wt. % Ni, about 31 wt. % Cr, about 26 wt. % Ta, and about 1 wt. % B, with a liquidus temperature of about 1232° C. (about 2250° F.); and (c) about 20 wt. % of a third low-melt powder including about 64 wt. % Ni, about 6 wt. % Al, about 8 wt. % Co, about 4 wt. % W, about 4 wt. % Ta, about 3 wt. % Si, about 1 wt. % Re, about 1 wt. % Nb, and about 1 wt. % B, with a liquidus temperature of about 1093° C. (about 2000° F.).

In some examples, the high-melt powder composition may include an alloy or mixture of alloys with a chemistry that is the similar to or substantially the same (e.g., the same or nearly the same) as the alloy in substrate 12. For example, in some implementations, when substrate 12 includes a Ni-based superalloy components, such as MAR-M 246 or 247, or CMSX-3 or CMSX-4, the high-melt powder composition may include between about 50 wt. % and about 70 wt. % Ni, between about 2 wt. % and about 10 wt. % Cr, between about 2 wt. % and about 10 wt. % Ta, between about 5 wt. % and about 15 wt. % Co, between about 2 wt. % and about 10 wt. % Al, between about 2 wt. % and about 10 wt. % W, between about 2 wt. % and about 4 wt. % Re, up to about 3 wt. % Mo, and up to about 3 wt. % Hf. In some examples, the high-melt powder composition also may include up to about 1 wt. % each of at least one of Ti, Nb, C, B, Si, or Zr. In some examples, the high-melt powder composition includes between about 55 wt. % and about 60 wt. % Ni, about 7 wt. % Cr, about 6 wt. % Ta, about 12 wt. % Co, about 6 wt. % Al, about 3 wt. % Re, about 1.5 wt. % Hf, and about 5 wt. % W.

The low-melt powder composition and the high-melt powder composition may be combined in any selected ratio. In some examples, preform 116 and or braze paste 118 may include a powder mixture consisting of between about 10 wt. % and about 80 wt. %, such as between about 20 wt. % to about 40 wt. %, low-melt powder composition and a balance high-melt powder composition. In some cases, braze alloy powder may be a mixture of two or more braze alloys.

Hence, in some examples, preform 116 may include between about 50 wt. % and about 90 wt. % Ni, up to about 15 wt. % Cr, up to about 10 wt. % Ta, up to about 10 wt. % Co, up to about 7 wt. % Al, up to about 4 wt. % W, up to about 2 wt. % Re, up to about 1 wt. % Mo, up to about 1 wt. % Hf, and, optionally, up to about 0.5 wt. % Nb, up to about 3 wt. % Si, and up to about 3 wt. % B. In some examples, PSP reinforcement 14 may include between about 50 wt. % and about 70 wt. % Ni, between about 10 wt. % and about 15 wt. % Cr, between about 8 wt. % and about 10 wt. % Ta, between about 8 wt. % and about 10 wt. % Co, between about 4 wt. % and about 7 wt. % Al, between about 2 wt. % and about 4 wt. % W, between about 1 wt. % and about 2 wt. % Re, about 1 wt. % Mo, about 1 wt. % Hf, and, optionally, up to about 1% each at least one of Ti, Nb, Pd, Pt, Ir, Ru, C, B, Si, P, Mn, Fe, Ce, La, Y, or Zr. In some examples, preform 116 and/or braze paste 118 may include between about 50 wt. % and about 70 wt. % Ni, between about 10 wt. % and about 15 wt. % Cr, between about 8 wt. % and about 10 wt. % Ta, between about 8 wt. % and about 10 wt. % Co, between about 4 wt. % and about 7 wt. % Al, between about 2 wt. % and about 4 wt. % W, between about 1 wt. % and about 2 wt. % Re, between about 0.5 wt. % and about 1 wt. % Mo, between about 0.5 wt. % and about 1 wt. % Hf, between about 0.1 wt. % and about 0.5 wt. % Nb, between about 0.05 wt. % and about 3 wt. % Si, and between about 0.5 wt. % and about 2 wt. % B.

In some examples, preform 116 and/or braze paste 118 may include about 58 wt. % Ni, about 11 wt. % Cr, about 9 wt. % Ta, about 9 wt. % Co, about 5 wt. % Al, about 3 wt. % W, about 1 wt. % Mo, about 1 wt. % Re, and about 1 wt. % Hf; or may include between about 10.2 wt. % and about 11.3 wt. % Cr, between about 4.8 wt. % and about 5.1 wt. % Al, between about 9.1 wt. % and about 9.8 wt. % Co, between about 2.8 wt. % and about 3.3 wt. % W, between about 0.7 wt. % and about 0.9 wt. % Mo, between about 8.2 wt. % and about 8.8 wt. % Ta, between about 0.6 wt. % and about 0.8 wt. % B, about 0.3 wt. % Si, between about 1.5 wt. % and about 1.8 wt. % Re, between about 0.8 wt. % and about 0.9 wt. % Hf, between about 0.1 wt. % and about 0.2 wt. % Nb, and a balance Ni.

In selecting the proportions of components used in preform 116 and braze paste 118, higher weight percentages of high-melt powder may provide better mechanical properties in view of their reduced levels of boron, silicon, or both, and thus may be included in high percentages in preform 116. Conversely, higher percentages of low-melt powders may provide improved braze flow and/or reduce exposure of a substrate to temperatures that may damage the substrate, and thus may be chosen in higher percentages for braze paste 118. The composition of the low-melt powder and high-melt powders, as well as the ratios thereof, may be controlled to provide selected brazing characteristics (e.g., flow, diffusion bonding, brazing temperature range, or the like) and selected physical properties (e.g., chemical and mechanical) of the brazed component.

In some examples, a powder composition that includes higher Al content may possess improved high-temperature oxidation resistance properties compared to a powder with lower Al content. In some examples, a powder composition that includes higher Ta content may possess improve mechanical properties compared to lower Ta content. For example, without being bound to any particular theory, Ta may strengthen the gamma and gamma prime phases by increasing lattice mismatches. In some examples, a powder composition that includes a nickel superalloy and about 0.5 wt. % boron may have improved mechanical strength and weldability compared to a nickel superalloy without boron.

In some examples, preform 116 may be formed by mixing one or more braze alloy powders and one or more superalloy powders in a selected composition, then sintering the mixed powder while disposed in a mold to form a sintered preform with reduced porosity. The sintering temperature and the duration of the sintering may depend at least in part on the composition of braze alloy powders.

In some examples, the sintered powder may then be cut or machined into a predetermined shape. The predetermined shape may correspond to a shape of a surface of substrate 12. For example, substrate 112 may include a relatively simple geometry, as illustrated, or may include a more complex geometry, e.g., multiple planes or surfaces, simple or complex curves, seams, or the like. Accordingly, the sintered powder may be cut or machined into a relatively simple shape, or a more complex, e.g., including curvature, angles, apertures, or the like to form preform 116. Regardless of the complexity of the shape of preform 116, preform 116 may include a substantially two-dimensional shape (e.g., a plane) or a three-dimensional shape (e.g., including curvature, planes at angles with respect to one another, and the like).

Pressurized fluid subsystem 106 is configured to elevate the atmospheric pressure of processing environment 104 to above ambient atmospheric pressure. In some examples, pressurized fluid subsystem may be configured to elevate processing environment 104 to a relatively high pressure during a HIP cycle. For example, pressurized fluid subsystem 106 may be configured to achieve an atmospheric pressure of at least about 10 megapascals (MPa) in processing environment 104, such as at least about 50 MPa, or at least about 100 MPa. The term “about” as used herein, includes the stated value and those values within 10 percent of the stated value.

Pressurized fluid subsystem 106 may may include any source of fluid that can be pressurized to exert pressure on substrate 12 and the applied braze material and, ultimately, braze repaired component 110. For example, pressurized fluid subsystem 106 may include a container holding a fluid and a pump for increasing the pressure of the fluid. The fluid may be compressible (e.g., a gas) or incompressible (e.g., a liquid). Pressurized fluid subsystem 106 may provide pressurized fluid to processing chamber 104, e.g., via piping or conduit. In some examples, the pressurized may be selected to be substantially chemically inert (e.g., not reactive) with the materials from which component 110 is formed (e.g., argon). In some examples, pressurized fluid subsystem 106 may include pressure sensor 162 disposed within processing environment 104. Electrical communication between pressure sensor 162 and pressurized fluid subsystem 106may allow for feedback control of the atmospheric pressure within processing environment 104 by pressurized fluid subsystem 106.

In some examples, rather than including a pressurized fluid subsystem 106 that is configured to supply pressurized fluid to processing environment 104, processing environment 104 may be filled with fluid under atmospheric or nearly atmospheric pressure, and pressurized fluid system may include a mechanism for applying pressure to the fluid to pressurize the fluid. For example, one wall of chamber 102 may be movable under influence of a motor, a hydraulic system, and pneumatic system, or the like to apply pressure to the fluid. As another example, a piston or plunger may be extendable into the interior of processing environment 104 to exert atmospheric pressure on component 110.

Vacuum subsystem 108 may evacuate gases from processing environment 104 to reduce the atmospheric pressure within chamber 102. One or more steps of a brazing process may be conducted under a vacuum atmospheric pressure of less than about 0.1 MPa, such as less than about 100 Pa, or less than about 0.1 Pa. For example, processing circuitry of computing device 140 may actuate a vacuum pump to remove and expel gases from processing environment 104. In some examples, vacuum subsystem 108 may include pressure sensor 162 disposed within processing environment 104. Electrical communication between pressure sensor 162 and vacuum subsystem 108 may allow for feedback control of the atmospheric pressure within processing environment 104 by vacuum subsystem 108.

System 100 further includes heating subsystem 120 configured to add thermal energy to processing environment 104 to increase the temperature of processing environment 104 to brazing temperatures. In some examples, heating subsystem 120 may include induction coil 122 which heats processing environment 104 directly. Additionally, or alternatively, heating subsystem 120 may include one or more induction coils configured to preheat incoming fluids from pressurized fluid system 106. In some examples, heating subsystem 120 may include temperature sensor 160 disposed within processing environment 104. Electrical communication between temperature sensor 160 and heating subsystem 120 may allow for feedback control of the temperature within processing environment 104 by heating subsystem 120.

Optionally, system 100 includes cooling subsystem 130. Cooling subsystem 130 may cool processing environment 104 during a cooling or quenching step after a braze cycle, a diffusion cycle, or a rejuvenation cycle. In examples where cooling subsystem 130 is included, cooling subsystem 130 may include evaporator coil 132. A cooling fluid passing through evaporator coil 132 may receive thermal energy from processing environment 104 to cool processing environment 104 and transfer the received thermal energy to other components of cooling subsystem 130 (e.g., a condenser). Alternatively, processing environment 104 may be cooled by deactivated the heating subsystem, or by injecting relatively cool external gases with pressurized fluid subsystem 106 and/or cooling subsystem 130, which may be referred to as rapid gas quenching. In some examples, cooling subsystem 130 may include temperature sensor 160 disposed within processing environment 104. Electrical communication between temperature sensor 160 and cooling subsystem 130 may allow for feedback control of the temperature within processing environment 104 by cooling subsystem 130.

With concurrent reference to FIG. 2, operation of system 100 of FIG. 1 during a braze repair technique that includes a HIP cycle will be described. Initially, pressurized fluid subsystem 106 may inject a hydrogen into processing environment 104 to clean processing environment 104 in preparation for further processing (200). Cleaning chamber 102 may remove oxides, organics, or other contaminants from processing environment 104. In some examples, rather than or in addition to a partial pressure hydrogen injection step, other cleaning techniques may be employed including actuating vacuum system 108 to evacuate processing environment 104, or performing some other thermochemical cleaning technique, or performing a manual cleaning, or the like.

A braze material may be applied to substrate 112 of component 110 (202). In some examples, the braze material may include preform 116 and/or braze paste 118, although braze tapes, braze foil braze putties, or the like may be included as braze material. The braze material includes a low-melt powder and a high-melt powder. In some examples, the high-melt powder may be substantially similar to the materials that make up substrate 112 of component 110. In some examples, braze paste 118 may be applied to a wide gap in substrate 112, which may be a crack in repair region 114 or a gap surrounding preform 116. In some examples, the wide gap may be at least about 0.5 mm in width.

Component 110, including both substrate 112 and the braze material, may be placed into processing environment 104 of chamber 102. Stage 150 may mechanically support component 110 while positioned in chamber 102. In some examples, stage 150 may include shelves defining various levels, with each level configured to support one or more components in operation.

Processing circuitry of computing device 140 may actuate vacuum subsystem 108 to reduce the atmospheric pressure in processing environment 104 (e.g., to below ambient atmospheric pressure). Volatile components (e.g., fillers, binders, or the like) may outgas from the braze material in the reduced atmospheric pressure environment (206), which may be below about 0.1 MPa, such as less than about 100 Pa. The outgassing step may reduce the presence of voids or porosity in component 110 after the braze repair process. In some examples, the outgassing step be conducted for a temporal duration of from about 5 minutes to about 24 hours, such as from about 15 minutes to about 8 hours. Heating subsystem 120 may or not be actuated during the outgassing step. In some examples, heating subsystem 120 may be actuated during the outgassing step and processing environment 104 may be allowed to heat up during the outgassing step. Heating during the outgassing step may advantageously improve throughput and additionally promote volatilizing of volatile components from the braze material.

Heating subsystem 120 may be actuated by processing circuitry of computing device 140 to deliver thermal energy to processing environment 104 via induction coil 122. A braze cycle may be conducted by increasing the temperature of processing environment 104 to at least soften the low-melt powder of the braze material (208). In some examples, processing environment 104 may enclose a vacuum or substantially inert atmosphere during the braze cycle. For example, a substantially inert atmosphere may include an atmosphere including constituents that do not react with substrate 112 and the braze material at the temperatures and pressures experienced by processing environment 104. In some examples, the braze cycle may include increasing the temperature of processing environment 104 to between about 1093° C. (about 2000° F.) and about 1288° C. (about 2350° F.), such as to a braze temperature of about 1260° C. (about 2300° F.). The time for which component 110 is heated during the braze cycle may vary from about 10 minutes to about 60 minutes, for example between about 20 to 30 minutes.

In accordance with one or more examples of the present disclosure, pressurized fluid system 106 may increase the atmospheric in processing environment 104 during the braze cycle to above an ambient atmospheric pressure. In such examples, the braze cycle may thus be considered to include a HIP cycle, because heat is delivered in conjunction with elevated atmospheric pressure. Conducting the braze cycle as a HIP cycle may increase the flow of the braze material, which may improve the performance of the braze cycle and result in reduced voids and porosity of repair region 114 and substrate 112. In cases where the braze cycle is conducted as a HIP cycle, the temperatures and times required to conduct the braze cycle may be reduced relative to a braze cycle conducted in a vacuum or ambient environment, which may increase efficiency and throughput of the braze process.

In examples where the braze cycle is conducted as a HIP cycle, pressurized fluid subsystem 106 may inject fluid into processing environment until the atmospheric pressure of processing environment 104 reaches an elevated atmospheric pressure of at least about 10 megapascals (MPa), such as at least about 50 MPa, or at least about 100 MPa, greater than an ambient atmospheric pressure, as sensed by pressure sensor 162. The elevated pressure environment may be maintained for the duration of the braze cycle, or the elevated atmospheric pressure may be relieved before the braze cycle concludes, or the elevated pressure may be maintained beyond the application of thermal energy during the braze cycle.

Subsequent to preforming braze cycle step 208, component 110 may be allowed to cool in processing environment 104 (210). In some examples, to cool processing environment 104, heating subsystem 120 may be merely deactivated. Additionally, or alternatively, cooling subsystem 130 may actively cool processing environment 104 by circulating a cooling fluid through evaporator coil 132. In still other examples, pressurized fluid system 106 may inject relative cool gases from outside chamber 102 to cool processing environment 104, a technique which may be called rapid gas quenching. Rapid gas quenching may, in some examples, advantageously impart desirable material properties to component 110, and may enable increased throughput by cooling processing environment 104 relatively more quickly than waiting for the added thermal energy to dissipate.

During cooling step 210, the temperature in processing environment 104 may be reduced to below the solidus temperature of the low-melt component (e.g., a temperature below which all of the low-melt component is in a slid phase). In some examples, cooling step 210 may cool component 110 to ambient temperature to form a solid preform 116. For example, component 110 may be cooled in processing environment 104 to about 650° C. (about 1200° F.) at a rate that is slow enough to avoid thermal distortion, followed by cooled under flowing inert gas from pressurized fluid system 106 to about 65° C. (about 150° F.) or less.

Heating subsystem 120 may be actuated by processing circuitry of computing device 140 to deliver thermal energy to processing environment 104 via induction coil 122. A diffusion cycle may be conducted by increasing the temperature of processing environment 104 to heat to the braze material to diffuse the braze material into substrate 112 and join the braze material to substrate 112 (212). The diffusion cycle may homogenize an interface between repair region 114 and the unrepaired portions of substrate 112.

In some examples, the diffusion cycle may be performed at temperatures between about 0° C. (about 0 ° F.) and about 222° C. (about 400° F.) below the braze temperature (e.g., below the temperature of processing environment 104 during the braze cycle), and for times of up to about 24 hours. For example, the post-brazing diffusion cycle may include a stepped diffusion cycle at a temperature of about 1149° C. (about 2100° F. for about 1 hour to about 18 hours. In some examples, during the diffusion cycle, processing environment 104 may define a vacuum or ambient atmosphere.

In some examples, the stepped diffusion cycle may include heating component 110 at a rate of between about 11° C./minute (about 20° F./minute) and about 22° C./minute (about 40° F./minute) to a first temperature of between about 982° C. (about 1800° F.) and about 1093° C. (about 2000° F.). In some examples, component 110 may be held at the first temperature for about 30 minutes to about 4 hours. The stepped heat treatment may also include heating component 110 to a second temperature of between about 1038° C. (about 1900° F.) and about 1149° C. (about 2100° F.) at a rate of between about 5.6° C./minute (about 10° F./minute) and about 16.7° C./minute (about 30° F./minute). Component 110 may be held at the second temperature for between about 1 hour and about 4 hours. In some examples, the stepped heat treatment further includes heating component 110 to a third temperature of between about 1066° C. (about 1950° F.) and about 1177° C. (about 2150° F.) at a rate of between about 2.8° C./minute (about 5° F./minute) and about 11° C./minute (about 20° F./minute). Component 110 may be held at the third temperature for between about 1 hour and about 4 hours. The stepped heat treatment also may include heating component 10 to a fourth temperature of between about 1093° C. (about 2000° F.) and about 1204° C. (about 2200° F.) at a rate of between about 2.8° C./minute (about 5° F./minute) and about 11° C./minute (about 20° F./minute). Component 110 may be held at the fourth temperature for between about 6 hours and about 24 hours.

In some examples, component 110 may be heated at a rate of about 16.7° C./minute (about 30° F./minute) to a first temperature of about 1038° C. (about 1900° F.) and held at about 1038° C. for about 1 hour to about 2 hours. Component 110 then may be heated to a second temperature of about 1093° C. (about 2000° F.) at a rate of about 11° C./minute (about 20° F./minute) and held at about 1093° C. for about 1 hour to about 2 hours. Component 110 then may be heated to a third temperature of about 1121° C. (about 2050° F.) at a rate of about 5.6° C./minute (about 10° F./minute) and held at about 1121° C. for about 1 hour to about 2 hours. Component 110 then may be heated to a fourth temperature of about 1149° C. (about 2100° F.) at rate of about 5.6° C./minute (about 10° F./minute) and held at about 1149° C. for about 1 hour to about 18 hours.

In accordance with one or more examples of the present disclosure, pressurized fluid system 106 may increase the atmospheric pressure in processing environment 104 during all or a portion of the diffusion cycle. In such examples, the diffusion cycle may thus be considered to include a HIP cycle, because heat is delivered in conjunction with elevated atmospheric pressure. Conducting the diffusion cycle as a HIP cycle may increase the diffusion rates of braze material into substrate 112 to join repair region 114 to substrate 112 relative to diffusion cycle conducted at vacuum or ambient atmospheric pressure. The increased diffusion rates during the HIP cycle may more efficiently eliminate intermetallic phases in repair region 114 and surrounding substrate 112, which may ultimately result in reduced non-conforming continuous eutectic phases.

In cases where the diffusion cycle is conducted as a HIP cycle, the temperatures and times required to conduct the diffusion cycle may be reduced relative to a diffusion cycle conducted in a vacuum or ambient environment, which may increase efficiency and throughput of the braze process. In examples where the diffusion cycle is conducted as a HIP cycle, pressurized fluid subsystem 106 may inject fluid into processing environment until the atmospheric pressure of processing environment 104 reaches at least about 10 megapascals (MPa), such as at least about 50 MPa, or at least about 100 MPa greater than an ambient atmospheric pressure. The elevated pressure environment may be maintained for the duration of the diffusion cycle, or the elevated atmospheric pressure may be relieved before the diffusion cycle concludes, or the elevated pressure may be maintained beyond the application of thermal energy during the diffusion cycle.

Subsequent to preforming diffusion cycle step 212, component 110 may be allowed to cool in processing environment 104 (214). In some examples, to cool processing environment 104, heating subsystem 120 may be merely deactivated. Additionally, or alternatively, cooling subsystem 130 may actively cool processing environment 104 by circulating a cooling fluid through evaporator coil 132. In still other examples, pressurized fluid system 106 may inject relative cool gases from outside chamber 102 to cool processing environment 104, which may be called rapid gas quenching. Rapid gas quenching may, in some examples, advantageously impart desirable material properties to component 110, and may enable increased throughout by cooling processing environment 104 relatively more quickly than waiting for the added thermal energy to dissipate.

During cooling step 214, the temperature in processing environment 104 may be reduced to below the solidus temperature of the low-melt component. In some examples, cooling step 210 may cool component 110 to ambient temperature. For example, component 110 may be cooled in processing environment 104 to about 650° C. (about 1200° F.) at a rate that is slow enough to avoid thermal distortion, followed by cooled under flowing inert gas from pressurized fluid system 106 to about 65° C. (about 150° F.) or less.

In examples described above, including some examples where the diffusion cycle is a stepped heat treatment process that occurs over a long time period, the technique of FIG. 2 may conclude after cooling step 214. In such examples, rejuvenation of the microstructure of substrate 112 to a gamma/gamma-prime microstructure may be accomplished during the diffusion cycle. However, in some examples, an optional rejuvenation cycle may be conducted subsequent to the diffusion cycle by applying heat via heating subsystem 220 to the braze material to restore a microstructure of substrate 112. In some examples, performing rejuvenation cycle step 216 may include increasing the temperature of processing environment 104 by applying heat to the braze material to restore a microstructure of substrate 112. In some examples, the rejuvenation cycle may restore a gamma/gamma-prime microstructure of substrate 112 that may have degraded during the braze cycle and/or the diffusion cycle. Restoring the microstructure of substrate 112 may reduce the risk of further damage of substrate 112 when braze-repaired component 110 is returned to service. In some examples, to perform rejuvenation cycle step 216, heating subsystem 220 may be actuated to increase the temperature in processing environment 104 to a temperature of between about 900° C. (about 1650° F.) and about 1100° C. (about 2000° F.). Component 110 may be held at the rejuvenation cycle temperature for between about 6 hours and about 24 hours.

In accordance with one or more examples of the present disclosure, pressurized fluid system 106 may increase the atmospheric pressure in processing environment 104 during all or a portion of the rejuvenation cycle. In such examples, the rejuvenation cycle may thus be considered to include a HIP cycle, because heat is delivered in conjunction with elevated atmospheric pressure. Conducting the diffusion cycle as a HIP cycle may increase the rate of restoration of the gamma/gamma-prime microstructure of substrate 112.

In cases where the rejuvenation cycle is conducted as an HIP cycle, the temperatures and times required to conduct the rejuvenation cycle may be reduced relative to a rejuvenation cycle conducted in a vacuum or ambient environment, which may increase efficiency and throughput of the braze process. In examples where the rejuvenation cycle is conducted as a HIP cycle, pressurized fluid subsystem 106 may inject fluid into processing environment until the atmospheric pressure of processing environment 104 reaches at least about 10 megapascals (MPa), such as at least about 50 MPa, or at least about 100 MPa. The elevated pressure environment may be maintained for the duration of the rejuvenation cycle, or the elevated atmospheric pressure may be relieved before the rejuvenation cycle concludes, or the elevated pressure may be maintained beyond the application of thermal energy during the rejuvenation cycle.

Subsequent to performing optional rejuvenation cycle step 216, component 110 may be allowed to cool in processing environment 104, as described above (218). During cooling step 218, the temperature in processing environment 104 may be reduced to ambient temperature to form a braze-repaired component. For example, component 110 may be cooled in a vacuum or inert gas furnace to about 650° C. (about 1200° F.) at a rate that is slow enough to avoid thermal distortion, followed by cooled under flowing inert gas from pressurized fluid system 106 to about 65° C. (about 150° F.) or less.

In some examples, the technique of FIG. 2 includes removing component 110 and substrate 112 from processing environment 104 (220). As such, the disclosed systems and techniques may enable a complete post-application treatment of component 110 in system 100 to result in relatively high quality braze-repaired component enable by inclusion of at least one HIP cycle. Braze-repaired component may thus be produced with relatively reduced labor and reduced time relative to other systems which are not configured to adjust the pressure within processing environment 104 between a less than atmospheric pressure regime and an elevated atmospheric pressure regime.

In some examples, the technique of FIG. 2 may include one or more additional processing steps including, but not limited to stress relief, additional sintering, solutionizing, annealing, aging, tempering, machining, polishing, shot peening, laser shock peening, or coating. The one or more additional processing steps may provide desired mechanical properties, physical properties, thermal resistance, chemical resistance, or the like.

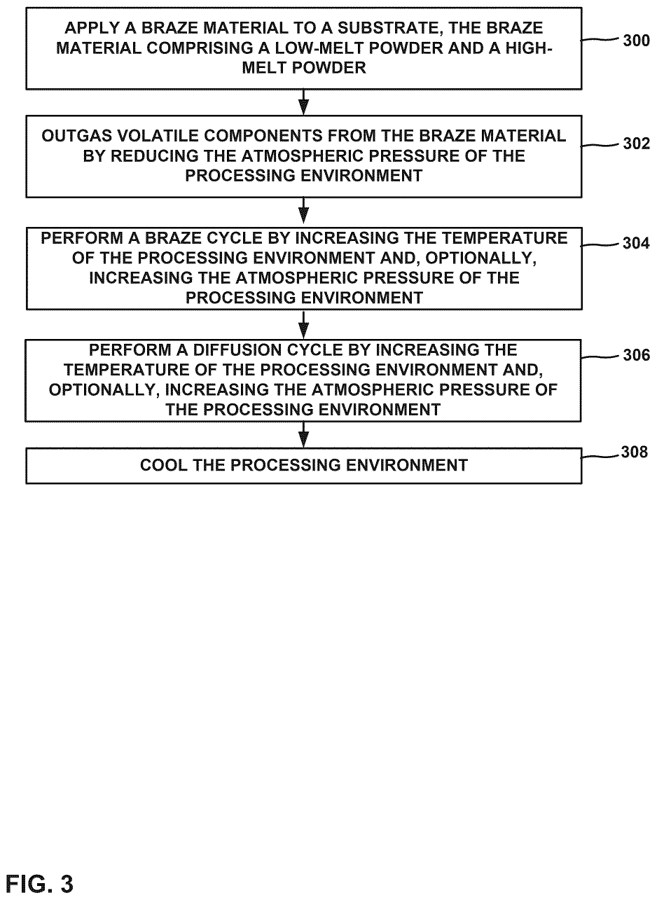

FIG. 3 is a flowchart illustrating a technique for repairing a component by brazing, in accordance with one or more examples of the present disclosure. System 100 of FIG. 1 will be described in conjunction with the technique of FIG. 3, although system 100 may be used to perform other techniques, and the described techniques may be performed with other systems.

A braze material may be applied to substrate 112 of component 110 (300). In some examples, the braze material may include preform 116 and/or braze paste 118, although braze tapes, braze foil braze putties, or the like may be included as braze material. The braze material includes a low-melt powder and a high-melt powder. In some examples, the high-melt powder may be substantially similar to the materials that make up substrate 112 of component 110. In some examples, braze paste 118 may be applied to a wide gap in substrate 112, which may be a crack in repair region 114 or a gap surrounding preform 116. In some examples, the wide gap may be at least about 0.5 mm in width.

Processing circuitry of computing device 140 may actuate vacuum subsystem 108 to reduce the atmospheric pressure in processing environment 104 (e.g., to below ambient atmospheric pressure). Volatile components (e.g., fillers, binders, or the like) may outgas from the braze material in the reduced atmospheric pressure environment (302), which may be below about 0.1 MPa, such as less than about 100 Pa. The outgassing step may reduce the presence of voids or porosity in component 110 after the braze repair process. In some examples, the outgassing step be conducted for a temporal duration of from about 5 minutes to about 24 hours, such as from about 15 minutes to about 8 hours. Heating subsystem 120 may or not be actuated during the outgassing step. In some examples, heating subsystem 120 may be actuated during the outgassing step and processing environment 104 may be allowed to heat up during the outgassing step. Heating during the outgassing step may advantageously improve throughput and additionally promote volatilizing of volatile components from the braze material.

Heating subsystem 120 may be actuated by processing circuitry of computing device 140 to deliver thermal energy to processing environment 104 via induction coil 122. A braze cycle may be conducted by increasing the temperature of processing environment 104 to at least soften the low-melt powder of the braze material (306). In some examples, processing environment 104 may enclose a vacuum or substantially inert atmosphere during the braze cycle. For example, a substantially inert atmosphere may include an atmosphere including constituents that do not react with substrate 112 and the braze material at the temperatures and pressures experienced by processing environment 104. In some examples, the braze cycle may include increasing the temperature of processing environment 104 to between about 1093° C. (about 2000° F.) and about 1288° C. (about 2350° F.), such as to a braze temperature of about 1260° C. (about 2300° F.). The time for which component 110 is heated during the braze cycle may vary from about 10 minutes to about 60 minutes, for example between about 20 to 30 minutes.

Heating subsystem 120 may be actuated by processing circuitry of computing device 140 to deliver thermal energy to processing environment 104 via induction coil 122. A diffusion cycle may be conducted by increasing the temperature of processing environment 104 to heat to the braze material to diffuse the braze material into substrate 112 and join the braze material to substrate 112 (306). The diffusion cycle may homogenize an interface between repair region 114 and the unrepaired portions of substrate 112.

In some examples, the diffusion cycle may be performed at temperatures between about 0° C. (about 0 ° F.) and about 222° C. (about 400° F.) below the braze temperature (e.g., below the temperature of processing environment 104 during the braze cycle), and for times of up to about 24 hours. For example, the post-brazing diffusion cycle may include a stepped diffusion cycle at a temperature of about 1149° C. (about 2100° F. for about 1 hour to about 18 hours. In some examples, during the diffusion cycle, processing environment 104 may define a vacuum or ambient atmosphere.

In accordance with one or more examples of the present disclosure, pressurized fluid system 106 may increase the atmospheric in processing environment 104 during the braze cycle, the diffusion cycle, or both. Therefore, at least one of the braze cycle or the diffusion cycle is a HIP cycle, because heat is delivered in conjunction with elevated atmospheric pressure. Conducting at least one of the braze cycle or the diffusion cycle as a HIP cycle may may improve the performance of resulting braze-repaired component 110.

Subsequent to preforming braze cycle step 208, component 110 may be allowed to cool in processing environment 104 (308). In some examples, to cool processing environment 104, heating subsystem 120 may be merely deactivated. Additionally, or alternatively, cooling subsystem 130 may actively cool processing environment 104 by circulating a cooling fluid through evaporator coil 132. In still other examples, pressurized fluid system 106 may inject relative cool gases from outside chamber 102 to cool processing environment 104, a technique which may be called rapid gas quenching. Rapid gas quenching may, in some examples, advantageously impart desirable material properties to component 110, and may enable increased throughput by cooling processing environment 104 relatively more quickly than waiting for the added thermal energy to dissipate.

During cooling step 210, the temperature in processing environment 104 may be reduced to below the solidus temperature of the low-melt component (e.g., a temperature below which all of the low-melt component is in a slid phase). In some examples, cooling step 210 may cool component 110 to ambient temperature to form a solid preform 116. For example, component 110 may be cooled in processing environment 104 to about 650° C. (about 1200° F.) at a rate that is slow enough to avoid thermal distortion, followed by cooled under flowing inert gas from pressurized fluid system 106 to about 65° C. (about 150° F.) or less.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Various examples have been described. These and other examples are within the scope of the following numbered examples and claims.

Example 1: A method for brazing includes applying a braze material to a substrate, the braze material comprising a low-melt component and a high-melt component; outgassing, while the braze material is under vacuum, volatile components from the braze material; performing a braze cycle, wherein performing the braze cycle comprises applying heat to the braze material that at least softens the low-melt component of the braze material; performing a diffusion cycle, wherein performing the diffusion cycle comprises applying heat to the braze material that at least diffuses the braze material into the substrate thereby joining the braze material to the substrate; wherein at least one of the braze cycle or the diffusion cycle comprises performing a hot isostatic pressure (HIP) cycle, wherein performing the HIP cycle comprises applying elevated atmospheric pressure in conjunction with the heat applied to the braze material; and cooling the substrate to form a brazed component.

Example 2: The method of example 1, and wherein the method further comprises, subsequent to performing the braze cycle and before performing the diffusion cycle, cooling the substrate.

Example 3: The method of example 2, further comprising applying elevated atmospheric pressure in conjunction with the applied heat during both the braze cycle and the diffusion cycle, such that performing braze cycle comprises performing a first HIP cycle and performing the diffusion cycle comprises performing a second HIP cycle.

Example 4: The method of example 3, further comprising, prior to outgassing volatile components under vacuum, placing the substrate into a chamber, and subsequent to performing the diffusion cycle, removing the substrate from the chamber.

Example 5: The method of any of examples 1 through 4, further comprising, subsequent to performing the diffusion cycle, cooling the substrate to a temperature that is below a solidus temperature, and performing a rejuvenation cycle, wherein performing the rejuvenation cycle comprises applying heat to the braze material to restore a microstructure of the substrate.

Example 6: The method of example 5, further comprising applying elevated atmospheric pressure in conjunction with the applied heat during the rejuvenation cycle, such that performing rejuvenation cycle comprises performing a HIP cycle.

Example 7: The method of any of examples 1 through 6, wherein applying the braze material comprises applying a braze paste, braze foil, or braze tape to a wide gap in the substrate.

Example 8: The method of example 7, wherein the wide gap is at least 0.5 millimeters (mm).

Example 9: The method of any of examples 7 and 8, wherein applying the braze material comprises applying a preform to a damaged portion of the substrate, and applying the braze paste or braze tape to a perimeter of the preform.

Example 10: The method of any of examples 1 through 9, wherein the substrate comprises a superalloy material.

Example 11: The method of any of examples 1 through 10, wherein the high-melt component is the same as the substrate material.

Example 12: The method of any of examples 1 through 11, wherein the low-melt component has a lower melting point than the high-melt component.

Example 13: The method of any of examples 1 through 12, wherein performing the HIP cycle comprises elevating the atmospheric pressure to at least about 10 megapascals (MPa) greater than ambient atmospheric pressure.

Example 14: The method of any of examples 1 through 13, further comprising, prior to outgassing volatile components from the braze material under vacuum, cleaning a processing environment for brazing.

Example 15: The method of example 14, wherein cleaning comprises injecting hydrogen gas into the processing environment.

Example 16: A system for forming a brazed component includes a chamber configured to receive a substrate with braze material applied to the substrate and contain the substrate within a processing environment; a vacuum system configured to evacuate gases from the processing environment; a pressurized fluid system configured to inject fluid into the processing environment to elevate an atmospheric pressure in the processing environment; a heating system configured to add thermal energy to the processing environment to increase a temperature of the processing environment; and processing circuitry, the processing circuitry configured to: actuate the vacuum system to reduce the atmospheric pressure in the processing environment to outgas volatile components from the braze material; actuate the heating system to perform a braze cycle to at least soften a low-melt component of the braze material; actuate the heating system to perform a diffusion cycle to diffuse the braze material into the substrate to join the braze material to the substrate; actuate the pressurized fluid system to inject fluid into the processing environment to increase the atmospheric pressure in the processing environment during at least one of the braze cycle or the diffusion cycle such that at least one of the braze cycle or the diffusion cycle comprises a hot isostatic pressure (HIP) cycle; and deactivate the heating system to cool the substrate to form a brazed component.

Example 17: The system of example 16, further comprising a cooling system configured to reduce a temperature of the processing environment.

Example 18: The system of example 17, wherein the processing circuitry is further configured to actuate the vacuum system and actuate the pressurized fluid system in succession without removing the substrate from the processing environment.

Example 19: The system of any of examples 16 through 18 wherein the processing circuitry is configured to cause a cleaning operation of a processing environment.

Example 20: The system of example 19, wherein cleaning comprises injecting hydrogen gas into the processing environment.

1. A method for brazing, the method comprising:
applying a braze material to a substrate, the braze material comprising a low-melt component and a high-melt component;
outgassing, while the braze material is under vacuum, volatile components from the braze material;
performing a braze cycle, wherein performing the braze cycle comprises applying heat to the braze material that at least softens the low-melt component of the braze material;
performing a diffusion cycle, wherein performing the diffusion cycle comprises applying heat to the braze material that at least diffuses the braze material into the substrate thereby joining the braze material to the substrate;
wherein at least one of the braze cycle or the diffusion cycle comprises performing a hot isostatic pressure (HIP) cycle, wherein performing the HIP cycle comprises applying elevated atmospheric pressure in conjunction with the heat applied to the braze material; and
cooling the substrate to form a brazed component.

2. The method of claim 1, and wherein the method further comprises, subsequent to performing the braze cycle and before performing the diffusion cycle, cooling the substrate.

3. The method of claim 2, further comprising applying elevated atmospheric pressure in conjunction with the applied heat during both the braze cycle and the diffusion cycle, such that performing braze cycle comprises performing a first HIP cycle and performing the diffusion cycle comprises performing a second HIP cycle.

4. The method of claim 3, further comprising, prior to outgassing volatile components under vacuum, placing the substrate into a chamber, and
subsequent to performing the diffusion cycle, removing the substrate from the chamber.

5. The method of claim 1, further comprising, subsequent to performing the diffusion cycle, cooling the substrate to a temperature that is below a solidus temperature, and
performing a rejuvenation cycle, wherein performing the rejuvenation cycle comprises applying heat to the braze material to restore a microstructure of the substrate.

6. The method of claim 5, further comprising applying elevated atmospheric pressure in conjunction with the applied heat during the rejuvenation cycle, such that performing rejuvenation cycle comprises performing a HIP cycle.

7. The method of claim 1, wherein applying the braze material comprises applying a braze paste, braze foil, or braze tape to a wide gap in the substrate.

8. The method of claim 7, wherein the wide gap is at least 0.5 millimeters (mm).

9. The method of claim 7, wherein applying the braze material comprises applying a preform to a damaged portion of the substrate, and applying the braze paste or braze tape to a perimeter of the preform.

10. The method of claim 1, wherein the substrate comprises a superalloy material.

11. The method of claim 1, wherein the high-melt component is the same as the substrate material.

12. The method of claim 1, wherein the low-melt component has a lower melting point than the high-melt component.

13. The method of claim 1, wherein performing the HIP cycle comprises elevating the atmospheric pressure to at least about 10 megapascals (MPa) greater than ambient atmospheric pressure.

14. The method of claim 1, further comprising, prior to outgassing volatile components from the braze material under vacuum, cleaning a processing environment for brazing.

15. The method of claim 14, wherein cleaning comprises injecting hydrogen gas into the processing environment.

16. A system for forming a brazed component, the system comprising:
a chamber configured to receive a substrate with braze material applied to the substrate and contain the substrate within a processing environment;
a vacuum system configured to evacuate gases from the processing environment;
a pressurized fluid system configured to inject fluid into the processing environment to elevate an atmospheric pressure in the processing environment;
a heating system configured to add thermal energy to the processing environment to increase a temperature of the processing environment; and
processing circuitry, the processing circuitry configured to:
actuate the vacuum system to reduce the atmospheric pressure in the processing environment to outgas volatile components from the braze material;
actuate the heating system to perform a braze cycle to at least soften a low-melt component of the braze material;
actuate the heating system to perform a diffusion cycle to diffuse the braze material into the substrate to join the braze material to the substrate;
actuate the pressurized fluid system to inject fluid into the processing environment to increase the atmospheric pressure in the processing environment during at least one of the braze cycle or the diffusion cycle such that at least one of the braze cycle or the diffusion cycle comprises a hot isostatic pressure (HIP) cycle; and
deactivate the heating system to cool the substrate to form a brazed component.

17. The system of claim 16, further comprising a cooling system configured to reduce a temperature of the processing environment.

18. The system of claim 17, wherein the processing circuitry is further configured to actuate the vacuum system and actuate the pressurized fluid system in succession without removing the substrate from the processing environment.

19. The system of claim 16 wherein the processing circuitry is configured to cause a cleaning operation of a processing environment.

20. The system of claim 19, wherein cleaning comprises injecting hydrogen gas into the processing environment.
